(19) United States
(12) Patent Application Publication
(10) Pub. No.: US 2008/0131666 A1
(43) Pub. Date: Jun. 5, 2008

(54) Penetration improvement of copper amine solutions into dried wood by addition of carbon dioxide

(76) Inventors: Roger F. Fox, Fayetteville, GA (US); Eugene A. Pasek, Ravenna, OH (US); Phillip F. Schneider, Decatur, GA (US); Jayesh P. Patel, Stone Mountain, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/146,293

(22) Filed: Dec. 14, 2005

Related U.S. Application Data
(63) Continuation-in-part of application No. 10/631,280, filed on Jul. 31, 2003, now abandoned.
Application No. 10/631,280 is a continuation-in-part of application No. 10/915,247, filed on Aug. 10, 2004, now abandoned.

(51) Int. Cl. B32B 3/12

(52) U.S. Cl. 428/158

(57) ABSTRACT

A method of performing an impregnating treatment on a resin-containing wood substrate using a fluid comprising the steps of providing the wood substrate, contacting the wood substrate with said fluid, and maintaining contact between the wood substrate and the fluid for a time period sufficient to obtain the desired penetration wherein the fluid is a wood protectant having a component selected from the group consisting essentially of carbon dioxide, its acid salts or combinations thereof added to adjust the basicity to a preferred pH range thereby improving fluid penetration and added moldicide stability.

### CROSS-REFERENCE TO RELATED APPLICATIONS

This application is a continuation-in-part of U.S. application Ser. No. 10/631,280 filed Jul. 31, 2003, and a continuation-in-part of U.S. application Ser. No. 10/915,247 filed Aug. 10, 2004 which is incorporated herein by reference.

### FIELD OF THE INVENTION

The present invention relates to a method of impregnation of a wood substrate by combining a wood protectant with a component selected from the group consisting essentially of carbon dioxide, its acid salts, or combinations thereof.

### BACKGROUND OF THE INVENTION

Wood is a natural organic material and as such is subject to biological and chemical degradation when placed in the appropriate environment. Wood preservatives, or protectants, such as insecticides, fungicides, bactericides, water repellents, dimensional stabilizers, and fire retardants are often applied to limit or prevent this degradation. Insects that degrade wood include termites, carpenter ants, and wood boring beetles and grubs. Fungi that degrade wood include decay fungi, soft-rot fungi, and mold. Lastly, bacteria may be tunneling or eroding types. They may cause wood to become unsightly or emit an unpleasant odor. And, they may cause degradation of some protectants.

There are known wood preservative compositions, which have been disclosed in U.S. Pat. Nos. 6,340,384; 5,916,356; RE36,798; 5,527,384; 5,078,912; 4,461,721; 5,187,194; 5,635,217; 5,426,121; 6,172,117; 6,340,384; 4,857,322; 5,304,237; 4,937,143 and 6,172,117 all of which are incorporated herein by reference. These disclose the dissolution of a metal in organic amine solution plus a co-biocide(s) to produce the preservative composition. Specifically, the metal is copper and the amine is an alkanolamine. In addition, U.S. Pat. No. 4,929,454 discloses ammonia based preservative composition; however, in the U.S. market the composition is such that an organic amine is substituted for ammonia.

Preservative compositions for solid wood products, includes an aqueous organic amine solution of a preservative metal compound and co-biocide(s). Before impregnating timber with any wood treating solution it is essential to season the timber until at least all the free water has been removed from the cell spaces. This stage of seasoning represents moisture content of about 10-25%, varying slightly with different species. It is not possible to inject another liquid into solid wood containing much water.

Each of the patents identified above is incorporated here by reference to provide background and contribute to the best mode, enablement, and written descriptions of this disclosure, and particularly to disclose how to make wood products.

### BRIEF SUMMARY OF THE INVENTION

One aspect of the invention is a composition of biocides, which may be comprised of a metal, an organic amine, co-biocide(s), and optionally other ingredients useful for wood preservation. The present invention is not limited to uses in which the wood is effectively preserved. Also, “preservation” is used broadly in this specification to refer to any treatment, which reduces the rate of deterioration of a wood or wood composite, compared to the rate of deterioration of an analogous wood or wood composite lacking the preservative.

Another aspect of the invention is the reduction of the basicity or pH of the wood preservation composition by the addition of an acid. A cost effective acid that has little deleterious affect on the preservative effectiveness against insect and fungal decay, as well as weathering and other properties, such as corrosion, conductivity, etcetera.

Another aspect of the invention is that the preservative composition is comprised of copper, and/or alkanolamine, and/or emulsified co-biocide, whereby the pH is reduced by the addition of carbon dioxide or its acid salts. Yet another aspect of the invention is a protected wood made by the method described above.

Another aspect of the invention is that the preservative composition is comprised of copper and/or ethanolamine and/or a co-biocide, whereby the pH of the preservative system is reduced by carbon dioxide or its acid salts.

One advantage of the present invention is that the addition of the treatment agents improve the penetration of the preservative solution throughout the sapwood of difficult to treated pine species, among which are Red pine (Pinus resinosa), Jack pine (Pinus banksiana) and Ponderosa pine (Pinus ponderosa).

Another advantage is that moldicides, used to prevent treated wood from becoming esthetically displeasing and perhaps unmarketable, are found to be more stable and last longer in the described compositions. These results are of extreme commercial value, since the moldicides tend to be costly.

As used herein the term “wood substrate” designates a substrate for the impregnation process which may typically be a shaped or partially shaped wood article, structural wood, timber, poles, etc. and may also encompass materials comprising comminuted wood such as chips or building plates etcetera.

Copper amine solution is useful as a wood protectant and is prepared by adding basic copper carbonate [Cu(OH)₂CuCO₃] or BCC to ethanolamine aqueous solutions or by the dissolution of metallic copper in ethanolamine solutions, containing carbon dioxide/carbonic acid/ethanolamine carbonate salts, plus oxygen or air. The copper to amine ratio can vary greatly, but a good working range is from about 2 to about 6 and advantageously from about 3 to about 4 moles of ethanolamine per mole of copper. For ethanolamine or monoethanolamine (MEA), the weight ratio is almost the same from about 2 to about 6 and advantageously from about 3 to about 4 MEA by weight to 1 Cu by weight. In addition, co-biocides may be added. With the present preservative an aqueous emulsion or tebuconazole is added. This results in the commercial formulation, having the name of Wolman® E (U.S. Pat. No. 5,916,356). In the United States the industry also adds quaternary ammonium salts, such as didecyldimethammonium or benzalkonium chlorides or carbonates, xylogen, naphthenates, etcetera. Many preservative formulations use the similar or the same copper amine or copper ethanolamine solutions.

The problem, as addressed above, with such solutions is that penetration of the treating solution into dried wood can vary from good to very poor. It is believed this is caused by the treating solution reacting with wood chemicals as it penetrates the wood. Specifically, it is felt that the wood chemicals are gluconuronic acids, which are sugar like molecules containing carboxylic acid functional groups. When isolated in the lab, these wood acids appear to form gum-like, sticky solids. Thus, as the treating solution is “pushed” into wood under pressure in the treating vessel, gluconuronic acid is first dissolved by the basic nature of the treating solution. However, as the treating solution front goes further into the wood, the acidity of the wood precipitates these materials causing closure of the wood pore structure, thus reducing the preservative penetration.

### BRIEF DESCRIPTION OF THE DRAWINGS

FIG. 1 shows the loss of moldicide (5-chloro-2-methyl-4-isothiazolin-3one or CMIT) with time in copper amine solutions having various bascities or pH.

FIG. 2 shows that the moldicide (CMIT) loss is first order with regard to moldicide and gives the rate constants for moldicide loss at the various basicities or pH value of the copper amine solution.

FIG. 3 shows the impact of basicity on the first order rate constant for moldicide loss.

### DETAILED DESCRIPTION OF THE INVENTION

While the invention will be described in connection with one or more embodiments, it will be understood that the invention is not limited to those embodiments. On the contrary, the invention includes all alternatives, modifications, and equivalents as may be included within the spirit and scope of the appended claims.

It has been found that by adding a component selected from the group consisting essentially of carbon dioxide, its acid salts, or combinations thereof, to these solutions (or preservative concentrates) improved penetration exists. It is thought that the added component acts as an acid to neutralize the hydroxides in the basic copper carbonate, [Cu(OH)₂CuCO₃], forming copper carbonate, CuCO₃. This can be illustrated from a copper amine solution made from BCC, having 4 moles of MEA per mole of copper:

Cu(MEA)₄(OH)₂+Cu(MEA)₄CO₃+CO₂→2Cu(MEA)₄CO₃+2H₂O

This lowers the pH of the treating solution. For example, a treating solution having a copper concentration of 0.3 weight % will have a pH of about 10.7-11.1. However, addition of carbon dioxide lowers the pH to about 9.0 to 9.5, while still maintaining copper stability/solubility within the treating solution. The lower pH reduces glucouronic acid dissolution and therefore reduces pore plugging and improves preservative penetration.

The two main issues with wood preservatives, such as copper amine solutions and including Wolman® E, are preservative penetration and the second is control of mold in the resulting treated wood product. There have been much effort and time spent to overcome these issues by using different additives. After several experiments it was concluded that addition of about 3.2% CO₂ in the Wolman® E concentrate or about 0.1% CO₂ in the treating solutions containing about 0.3% copper improve the penetration by greater than about 10%, and in some experiments greater than about 15%. The reduction in pH not only improves copper amine penetration, but provides a longer stability of mold inhibitors, which are typically chlorinated isothiazolinones, like mixtures of 2-methyl-4-isothiazolin-3-one (MIT) and 5-chloro-2-methyl-4-isothiazolin-3one (CMIT) commonly available as K-18500 from Arch Wood Protection, Inc. The addition of K-18500 in conjunction with another moldicide (Moldicide B) extends the mold control for longer time, reducing moldicide costs. Thus, the addition of CO₂, its acid salts, or combinations thereof, provides the extra benefit of increased stability of moldicide in addition to improved preservative penetration into the sapwood of the wood being treated against insect and fungal decay.

The present invention includes a method of performing an impregnating treatment on a lignocellulosic material substrate using a fluid comprising the steps of: providing a lignocellulosic material substrate; contacting the substrate with said fluid; and maintaining contact between the substrate and the fluid for a time period sufficient to obtain the desired penetration wherein the pH of the fluid is adjusted by the addition of a component selected from the group consisting essentially of carbon dioxide, its acid salts, or combinations thereof.

Advantageously said lignocellulosic material is wood. More advantageously said wood is from a coniferous tree and is impregnated using a wood preserving agent comprising at least one species selected from the group consisting essentially of fungicides, insecticides, and combinations thereof. Preferably the wood from a coniferous tree is selected from the group consisting essentially of spruce (pica), fir (abies, pseudotsuga), hemlock (tsuga), pine (pinus) and larch (larix).

Advantageously the impregnating treatment fluid contains at lease one ingredient selected from the group consisting essentially of copper amine, copper ethanolamine, copper monethanolamine and combinations thereof. Preferably wood from a coniferous tree is impregnated with a fluid containing at lease one organic biocide wherein the pH of the resulting fluid is adjusted to between about 8 and about 10 and more preferably the pH of the said fluid is adjusted to between about 8.5 to about 9.5.

Advantageously the at least one biocide is selected from the group consisting essentially of propiconazole, tebuconazole, and combinations thereof. More advantageously the biocide is dissolved in a solvent before the pH is adjusted. Preferably such solvent is an emulsifier.

Advantageously the wood substrate is further impregnated with an additional agent selected from the group consisting essentially of colorants, fireproofing agents, strength-improvement agents, and combinations thereof.

The present invention further includes a method for forming lignocellulosic-based composite products which are resistant to insect and fungal attack wherein the improvement comprises incorporating a metal amine and an ingredient selected from the group consisting essentially of a pesticide, a fungicide, and combinations thereof and including the step of adjusting the pH to between 8.5 to 9.5 by the addition of a component selected from the group consisting essentially of carbon dioxide, its acid salts, or combinations thereof. A composite lignocellulosic-based product having resistance to insect and fungal attack, and produced by said method thereto prior to forming said composite product is also included in the present invention.

### EXAMPLE 1

### Improved Preservative Penetration

Eight Red pine 4×4 inch boards were cut into 4-inch long sections and a section from each board was assigned to a different preservative treatment. Each treatment was applied to all eight sections at the same time in the same pressure treatment cylinder. The Wolman E solution used for these treatments were: no additive (control); the solution containing the invention, carbon dioxide; ammonium bicarbonate; and ammonium hydroxide. Typically, ammonia containing preservatives penetrate the more refractory wood species, such as Red pine (Pinus resinosa); thus, both ammonium carbonate and ammonia were added to the Wolman E treatment solution and examined for preservative penetration in this study.

The ends of each section were sealed with epoxy to assure that the preservative solution entered through the sides of the samples. This simulates the treatment of large pieces of wood, where the preservative solution predominantly enters through the ray pore wood structure. Ray pores occur perpendicular to the growth of a tree.

All treatments consisted of a fresh Wolman E solution containing 0.3% copper (Cu). The pressure treating process consisted of an initial vacuum of 24 inches of mercury (Hg) for 15 minutes, a 150-psi pressure press for 30 minutes, and a final vacuum of 24 inches Hg for 15 minutes. After the treating, the sections were cut open and the preservative penetration measured. Heart/Sapwood and copper indicators (American Wood Preservers' Association Standards 2003, A3-00) were sprayed on the sections and samples were recorded using a computer scanner.

Penetration values were averaged for the eight sections from each treatment. The results are shown in Table 1.

TABLE 1
Preservative Penetrations into Red Pine 4 × 4 Inch Lumber Sections Using a Shortened
Commercial Pressure Cycle.

| | | Carbon | | Ammonium | | | Amonium | |
|---|---|---|---|---|---|---|---|---|
| Control | | Dioxide | | Bicarbonate | | | Hydroxide | |
| | % | | % | | | % | | % |
| | Sapwood | Conc. | Sapwood | Conc. | Equivalent CQ | Sapwood | Conc. | Sapwood |
| No Additives | Treated | (% w/w) | Treated | (% w/w) | (% w/w) | Treated | (% w/w) | Treated |
| Block Set 1 | 62 | 0.12 | 70 | 0.08 | 0.04 | 64 | 0.1 | 60 |
| Block Set 2 | 63 | 0.2 | 67 | 0.1 | 0.06 | 66 | 0.17 | 68 |
| Block Set 3 | 57 | 0.24 | 74 | 0.17 | 0.09 | 72 | 0.17 | 65 |
| Block Set 3 # 2 | 67 | 0.28 | 70 | 0.22 | 0.12 | 69 | 0.34 | 58 |
| Block Set 3 # 3 | 67 | 0.33 | 64 | 0.37 | 0.21 | 69 | 1 | 58 |
| Block Set 4 | 62 | 0.33 | 68 | 0.5 | 0.28 | 70 | 2.06 | 59 |
| Block Set 5 | 62 | | | 1 | 0.56 | 65 | | |
| | | | | 1.5 | 0.84 | 70 | | |
| | | | | 2.3 | 1.28 | 71 | | |
| | | | | 2.33 | 1.3 | 79 | | |
| | | | | 3.5 | 1.95 | 72 | | |
| Average | 63 | | 69 | | | 70 | | 61 |
| Standard | 3 | | 3 | | | 4 | | 4 |
| Deviation | | | | | | | | |

The control preservative, Wolman E with no additive, penetrated 63% of the Red pine sapwood, which is portion of wood, generally accessible to liquids. When carbon dioxide was added, penetration increased to 69% of the sapwood. This improvement, although not large (some 10%), can make a considerable difference on a commercial scale.

The addition of ammonium bicarbonate also significantly improved preservative solution penetration into the sapwood. It is reasonable to assume that the bicarbonate ion neutralized the strong base hydroxides originating from the copper hydroxide in the BCC. The by-product ammonium hydroxide is a weak base, thus reducing the overall basicity of the treatment solution:

Cu(MEA)₄(OH)₂+NH₄HCO₃→Cu(MEA)₄CO₃+NH₄OH+H₂O

### However, although ammonium bicarbonate improves preservative penetration into Red pine, the by-product ammonia has an odor, which could be offensive for some applications.

The ammonium hydroxide treatments were included to show that the ammonia component of ammonium bicarbonate did not influence penetration. There was little difference between the penetration results form the control and ammonium hydroxide treatments. If anything, the ammonia additive reduced preservative penetration slightly, about a 3% reduction, which is probably caused by the slight increase in overall hydroxide ions or basicity.

### EXAMPLE 2

### Penetration Improvement from Bicarbonate

Fifteen 12 foot 4×4 inch boards of Red pine were cut into 6 foot lengths and labeled “A” or “B”. The “A” halves were treated with a solution of Wolman E without additives. The “B” halves were treated with a similar Wolman E solution after adding 0.47% ammonium bicarbonate (equivalent to 0.26% CO₂). Each treatment was applied to all fifteen sections at the same time in the same cylinder. The pressure treating process consisted of an initial vacuum of 24 inches Hg for 10 minutes, a 175-psi pressure period for 60 minutes, and a final vacuum of 24 inches Hg for 60 minutes. After treating, the boards were cut in half and the preservative penetration measured as percent of sapwood treated. Penetration values were averaged for the fifteen sections from each treatment. The results are shown in Table 2.

TABLE 2
Penetration Improvement from Bicarbonate Using Commercial Cycles

% Sapwood Treated

| | | Wolman E + 0.47% |
|---|---|---|
| | Wolman E | Ammonium |
| Sample | Control | Bicarbonate |
| 1 | 96 | 100 |
| 2 | 66 | 80 |
| 3 | 60 | 85 |
| 4 | 44 | 87 |
| 5 | 100 | 81 |
| 6 | 60 | 87 |
| 7 | 79 | 80 |
| 8 | 100 | 97 |
| 9 | 100 | 100 |
| 10 | 54 | 92 |
| 11 | 100 | 100 |
| 12 | 92 | 93 |
| 13 | 68 | 98 |
| 14 | 84 | 96 |
| 15 | 89 | 92 |
| Average | 80 | 91 |
| St. Dev. | 19 | 8 |

Because of the large penetration variations in the control sections, there was no statistical difference between the treatments. However, twelve of the fifteen sections receiving the ammonium bicarbonate treatment had sapwood penetrations of 85% or greater, while, only seven of the control sections achieved this level of penetration. This difference is very meaningful when wood is being treated to the specifications outlined by the American Wood Preservers' Association Standards (AWPA 2003).

### EXAMPLE 3

### Preservative Sapwood Penetration Improvements with Carbon Dioxide

Eight-foot ponderosa pine (Pinus ponderosa) 2×6 inch lumber was cut into 4 oott end-matched sections and sequentially labeled “A” or “B”. All of the “A” sections were treated with a Wolman E solution, containing 0.3% copper and no additives. This control treatment was applied in three charges containing 20 sections each. The pressure treating process consisted of an initial vacuum of 24 inches Hg for 10 minutes, a 175-psi pressure cycle for 60 minutes, and a final vacuum of 24 inches Hg for 10 minutes. After treating, the sections were cut open at the mid point of each board and the preservative penetration measured as percent of sapwood treated. The matched “B” sections for those “A” sections that had low penetration values were grouped into sets of six and treated with Wolman E, containing 0.3% copper and added 0.3, 0.4, or 0.8% carbon dioxide. The same pressure process was used for these sections. The resulting preservative penetration values are shown in Table 3. The average penetration in terms of percent sapwood treated was consistently 5 greater for the sections receiving the CO₂ treatments. Penetration variations in the control and matched samples for the 0.3% and 0.4% CO₂ treatments were just large enough to eliminate statistical differences between these treatments. However, from a commercial standpoint, these differences were meaningful. At the 0.8% treatment level, the CO₂ resulted in a significant greater preservative penetration.

TABLE 3
Preservative Penetrations as Percent Sapwood
for Ponderosa Pine: 2 × 6″

Wolman E Control

| | | | |
|---|---|---|---|
| | % Sapwood | | % Sapwood |
| Sample | Treated | Sample | Treated |

Wolman E + 0.3% CO₂

| | | | |
|---|---|---|---|
| 7812 6A | 86 | 7812 6B | 82 |
| 7812 7A | 77 | 7812 7B | 98 |
| 7812 9A | 61 | 7812 9B | 76 |
| 7812 11A | 69 | 7812 11B | 82 |
| 7812 14A | 60 | 7812 14B | 79 |
| 7812 15A | 70 | 7812 15B | 66 |
| Average | 71 | | 81 |
| St. Dev. | 10 | | 11 |

Wolman E + 0.4% CO₂

| | | | |
|---|---|---|---|
| 7830 18A | 29 | 7830 18B | 51 |
| 7830 20A | 83 | 7830 20B | 92 |
| 7830 21A | 86 | 7830 21B | 100 |
| 7830 22A | 97 | 7830 22B | 100 |
| 7830 24A | 97 | 7830 24B | 100 |
| 7830 25A | 99 | 7830 25B | 100 |
| Average | 82 | | 90 |
| St. Dev. | 27 | | 20 |

Wolman E + 0.8% CO₂

| | | | |
|---|---|---|---|
| 7813 13A | 81 | 7813 13B | 96 |
| 7813 14A | 77 | 7813 14B | 97 |
| 7813 15A | 81 | 7813 15B | 100 |
| 7813 17A | 91 | 7813 17B | 100 |
| 7813 19A | 85 | 7813 19B | 100 |
| 7813 20A | 95 | 7813 20B | 100 |
| Average | 85 | | 99 |
| St. Dev. | 7 | | 2 |

### EXAMPLE 4

Amine-based wood preservatives such as Wolman E protect wood from degradation by insects and decay fungi; however, they leave freshly treated wood susceptible to colonization by some mold species if the wood is not allowed to dry. To enhance the protection of wood, a moldicide is added to the preservative solution before the treating process. Typically these moldicides are isothiazolinones, such as mixtures 2-methyl-4-isothiazolin-3-one (MIT) and 5-chloro-2-methyl-4-isothiazolin-3one (CMIT) (K-18500, Arch Wood Protection). The ratio of CMIT to MIT in the K18500 product is 3:1, respectively. The CMIT component highly effective against molds and molds spore, but decomposes in the strongly basic solution. The MIT and other added moldicides (such as Moldiocide B) extend the mold control and are relatively stable in strongly basic solutions. However, lower the pH of the treatment solution extends the life of CMIT (and other added moldicides) to an acceptable duration for most commercial wood treating operations. The addition of carbon dioxide has been found to be an effective method to achieve this goal, without causing any deleterious impact on the treatment process or the treated wood product.

A solution of Wolman E, containing 0.3% copper, was prepared and separated into four containers. To three of the containers 0.4, 0.6, or 0.8% CO₂ was added, give rise to pH values of 10.37, 9.63, 9.50 and 9.15, respectively. All of the containers then received approximately 50 ppm of K18500 (equivalent to 38 ppm CMIT). The containers were covered and stored at ambient conditions. The solutions were analyzed for CMIT over one month and the resulting analyses shown in Table 4.

TABLE 4
Concentration of Moldicide CMIT in Wolman E Solution

| | | CMIT (ppm) | | | | | |
|---|---|---|---|---|---|---|---|
| Treatment | Solution pH | Day 1 | Day 3 | Day 7 | Day 10 | Day 14 | Day30 |
| Wolamn E Control | 10.37 | 28 | 5 | 0 | 0 | 0 | 0 |
| Wolman E + 0.4% CO₂ | 9.63 | 34 | 24 | 10 | 8 | 3 | 0 |
| Wolman E + 0.6% CO₂ | 9.50 | 37 | 30 | 15 | 12 | 7 | 0 |
| Wolman E + 0.8% CO₂ | 9.15 | 37 | 34 | 25 | 22 | 18 | 4 |

The addition of carbon dioxide to Wolman E treating solutions containing the moldicide K18500 substantially extended the life of the CMIT component of the moldicide. This amount of time would be sufficient for continuous commercial operation.

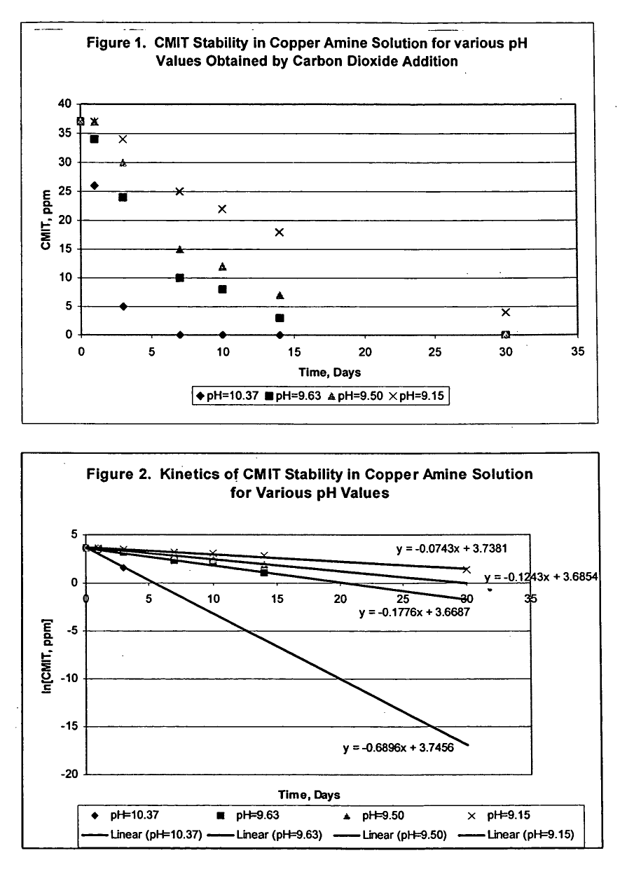

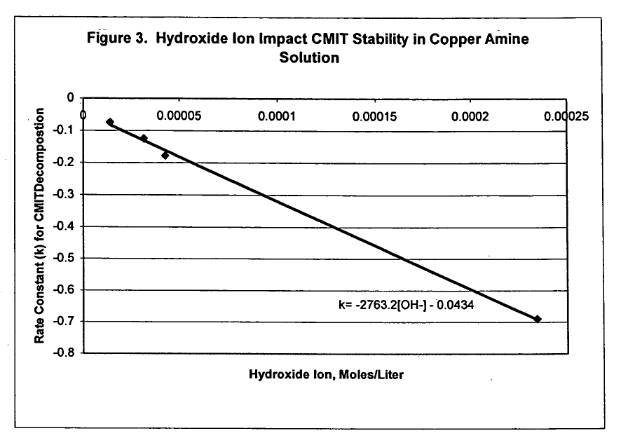

The reduction in CMIT is illustrated in FIG. 1. To investigate the chemistry of this CMIT stability versus pH, the logarithm of the CMIT was plotted versus the time (FIG. 2). FIG. 2 shows straight lines are obtained, indicating that the reaction is first order in CMIT concentration in ppm. The slopes of these lines are the rate constants for loss of CMIT with time for the various pH levels tested. FIG. 3 illustrates that these data can be used to assist in determine the rate of CMIT decomposition at any pH level. Of course, pH levels below about 8 may cause the copper amine complexes to decompose resulting in precipitation of insoluble copper carbonates.

A method to improve the protection of wood by amine-based wood preservatives has been discovered and demonstrated. The reduction of preservative pH, especially the use of carbon dioxide, helps to overcome preservative penetration limitations and enhance moldicide stability in these solutions. Both critical issues for commercial treatment of wood substrates using these metal amine systems.

The process of the invention is not restricted to biocide impregnation of wood substrate, but is also suitable for impregnation of wood substrate with one or more of the species of the groups: colorants, fireproofing agents, and other agents imparting specific qualities, e.g. strength-improving agents such as agents which are polymerized in situ after having been dispersed within the wood structure.

What is claimed is:

1. A method of performing an impregnating treatment on a lignocellulosic material substrate using a fluid comprising the steps of:
(i) providing a lignocellulosic material substrate;
(ii) contacting the substrate with said fluid; and
(iii) maintaining contact between the substrate and the fluid for a time period sufficient to obtain the desired penetration wherein the pH of the fluid is adjusted by the addition of a component selected from the group consisting essentially of carbon dioxide, its acid salts, or combinations thereof.

2. A composite product according to claim 1 in which said lignocellulosic material is wood.

3. A method according to claim 1, characterized in that said lignocellulosic material is wood from a coniferous tree and is impregnated using a wood preserving agent comprising at least one species selected from the group consisting essentially of fungicides, insecticides, and combinations thereof.

4. A method according to claim 3, characterized in that the wood from a coniferous tree is selected from the group consisting essentially of spruce (pica), fir (abies, pseudotsuga), hemlock (tsuga), pine (pinus) and larch (larix).

5. A method according to claim 1, characterized in that the impregnating treatment fluid contains at least one ingredient selected from the group consisting essentially of copper amine, copper ethanolamine, copper monoethanolamine and combinations thereof.

6. A method according to claim 4, characterized in that wood from a coniferous tree is impregnated with a fluid containing at least one organic biocide and wherein the pH of the resulting fluid is adjusted to between about 8 and about 10.

7. A method according to claim 1, whereby the pH of the said fluid is adjusted to between about 8.5 to about 9.5.

8. A method according to claim 6, wherein the at least one biocide is selected from the group consisting essentially of propiconazole, tebuconazole, and combinations thereof.

9. A method according to claim 6, characterized in that the biocide is dissolved in a solvent before the pH is adjusted.

10. The method of claim 9 wherein the solvent is an emulsifier.

11. A method according to claim 2, characterized in that the wood substrate is further impregnated with an additional agent selected from the group consisting essentially of colorants, fireproofing agents, strength-improving agents, and combinations thereof.

12. A method for forming lignocellulosic-based composite products which are resistant to insect and fungal attack wherein the improvement comprises incorporating a metal amine and an ingredient selected from the group consisting essentially of a pesticide, a fungicide, and combinations thereof and including the step of adjusting the pH to between 8.5 to 9.5 by addition of a component selected from the group consisting essentially of carbon dioxide, its acid salts, or combinations thereof.

13. A composite lignocellulosic-based product having resistance to insect and fungal attack, produced by the method according to claim 12.
